(19) United States
(12) Patent Application Publication
(10) Pub. No.: US 2015/0301248 A1
(43) Pub. Date: Oct. 22, 2015

(54) PROTECTION FILM AND POLARIZATION PLATE PROVIDED WITH PROTECTION FILM

(71) Applicant: Nitto Denko Corporation, Ibaraki-shi, Osaka (JP)

(72) Inventors: Akinori IZAKI, Ibaraki-shi, Osaka (JP); Mariko HIRAI, Ibaraki-shi, Osaka (JP); Keisuke KIMURA, Ibaraki-shi, Osaka (JP); Yuuji SAIKI, Ibaraki-shi, Osaka (JP); Hironori MOTOMURA, Ibaraki-shi, Osaka (JP)

(21) Appl. No.: 14/418,740

(22) PCT Filed: Oct. 2, 2012
(86) PCT No.: PCT/JP2012/075453

§ 371 Date: Jan. 30, 2015

(51) Int. Cl. G02B 5/30; B32B 7/06; B32B 7/12; B32B 27/08; B32B 27/36

(52) U.S. Cl. CPC G02B 5/305; B32B 27/08; B32B 27/36; B32B 7/12; B32B 7/06; B32B 2457/20; B32B 2307/51

(57) ABSTRACT

Provided is a protective film capable of satisfactorily suppressing warping of a polarizing plate. The protective film of the present invention, includes a first resin layer (11), an adhesion layer (13), and a second resin layer (12) in the stated order.

### TECHNICAL FIELD

The present invention relates to a protective film for a polarizing plate.

### BACKGROUND ART

In a liquid crystal display apparatus, which is a typical image display apparatus, a polarizing plate is bonded onto each of both aides of a liquid crystal cell on the basis of an image-forming mode of the liquid crystal display apparatus. The polarizing plate is generally constructed by laminating a protective layer on at least one side of a polarizer having polarizing performance from the viewpoint of, for example, improving mechanical durability and optical durability. However, the polarizing plate has a problem in that warping is liable to occur owing to, for example, differences in linear expansion, coefficient and thermal shrinkage coefficient between the polarizer and the protective layer. Such warping of the polarizing plate can be eliminated by, for example, bonding the polarizing plate onto a liquid crystal cell, but the warping becomes a cause for a problem in a manufacturing process (e.g., in a lamination step with another optical member or a bonding step onto a liquid crystal cell).

By the way, in the manufacturing process, a protective film is generally attached onto the polarizing plate (including an intermediate for the polarizing plate) (see, for example, Patent Literature 1). There is a proposal of suppressing the warping of the polarizing plate by the attachment of the protective film, but the suppression of the warping may be insufficient depending on the construction of the polarizing plate.

### CITATION LIST

### Patent Literature

[PTL 1] JP 3368524 B

### SUMMARY OF INVENTION

### Technical Problem

The present invention has been made to solve the problem of the related art, and a main object of the present invention is to provide a protective film capable of satisfactorily suppressing warping of a polarizing plate.

### Solution to Problem

A protective film of the present invention is a protective film for a polarizing plate including a first resin layer, an adhesion layer, and a second resin layer in the stated order.

In one embodiment of the invention, a value of a ratio of a thickness of the adhesion layer to a sum of a thickness of the first resin layer and a thickness of the second resin layer is 0.40 or less.

In another embodiment of the invention, the adhesion layer has a thickness of from 2 μm to 25 μm.

In still another embodiment of the invention, the resin layer includes a polyester-based resin film.

In still another embodiment of the invention, the resin layer has a modulus of elasticity of from 4.0 kN/mm² to 4.7 kN/mm².

In still another embodiment of the invention, the adhesion layer has a storage modulus of elasticity at 23° C. of 8.0×10⁴ Pa or more and less than 1.0×10⁷ Pa.

In still another embodiment of the invention, the protective film has a modulus of elasticity of from 3.5 kN/mm² to 3.8 kN/mm².

According to another aspect of the invention, there is provided a polarizing plate provided with a protective film. The polarizing plate provided with a protective film includes: a polarizing plate; and the above-mentioned protective film peelably attached onto a surface of the polarizing plate.

### Advantageous Effects of Invention

According to one embodiment of the present invention, it is possible to provide the protective film capable of more satisfactorily suppressing warping of a polarizing plate than a resin layer alone by laminating resin layers through the intermediation of an adhesion layer. One possible factor therefor is its higher second moment, of area than that of the resin layer alone, which can reduce its modulus of elasticity, In addition, by virtue of the reduction in modulus of elasticity, the amount of shrinkage upon application of a given, tension can be increased, and hence a load on equipment can be alleviated in the case where a tension is applied during the attachment of the protective film. Further, the protective film of such construction is excellent in bending property and is also excellent in peelability (in its removal from a polarizing plate), and hence allows an improvement in manufacturing efficiency to be achieved.

### BRIEF DESCRIPTION OF DRAWINGS

FIG. 1 is a schematic sectional view of a protective film according to a preferred embodiment of the present invention.

FIG. 2 is a schematic sectional view of a polarizing plate provided, with a protective film according to a preferred embodiment of the present invention.

### DESCRIPTION OF EMBODIMENTS

Hereinafter, preferred embodiments of the present invention are described. However, the present invention is not limited to these embodiments.

### A. Protective Film

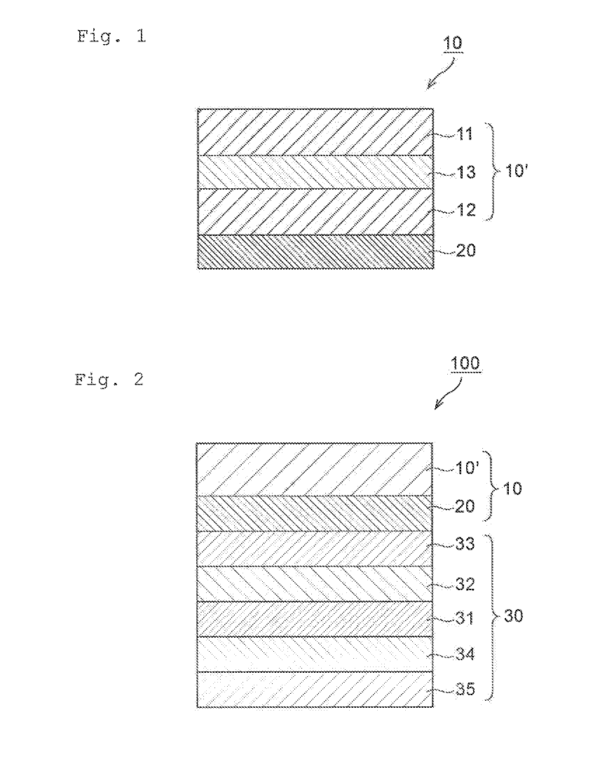

FIG. 1 is a schematic sectional view of a protective film according to a preferred embodiment of the present invention. A protective film 10 includes a first resin layer 11, an adhesion layer 13, and a second resin layer 12 in the stated order. The protective film 10 is a laminate 10′ in which the first resin layer 11 and the second resin layer 12 are laminated through the intermediation of the adhesion layer 13. In a practical case, the protective film 10 includes a pressure-sensitive adhesive layer 20 formed on the opposite side of the second resin layer 12 to the adhesion layer 13, and is attached onto a polarizing plate by means of the pressure-sensitive adhesive layer 20. It should be noted that a separator (not shown) is attached onto the surface of the pressure-sensitive adhesive layer 20 until the attachment of the protective film 10 onto a polarizing plate.

The thickness of the laminate is typically from 12 μm to 230 μm, preferably from 50 μm to 110 μm.

By adopting the form of the laminate, the modulus of elasticity of the protective film can be reduced as compared to the form of each of the resin layers alone (at least one of the resin layers). A difference between the modulus of elasticity of each of the resin layers alone and the modulus of elasticity of the protective film is preferably 0.2 kN/mm² or more. Meanwhile, a difference between the modulus of elasticity of each of the resin layers alone and the modulus of elasticity of the protective film is preferably 1.0 kN/mm² or less. The modulus of elasticity of the protective film is preferably from 3.5 kN/mm² to 3.3 kN/mm². It should be noted that the modulus of elasticity is measured in conformity with JIS K 6781.

By adopting the form of the laminate, the tensile elongation of the protective film can be increased as compared to the form of each of the resin layers alone (at least one of the resin layers). It should be noted that the tensile elongation is measured in conformity with JIS K 6781.

### A-1. Resin Layers

Resin films preferably serve as the resin layers. The thickness of each of the resin layers is typically from 5 μm to 100 μm, preferably from 25 μm to 50 μm.

The modulus of elasticity of each of the resin layers may be set to any appropriate value. The modulus of elasticity of each of the resin layers (modulus of elasticity of at least one of the resin layers) is preferably from 4.0 kN/mm² to 4.7 kN/mm².

A polyester-based resin is preferably used as a material for forming each of the resin layers.

It should be noted that the constructions of the first resin layer and the second resin layer (including their thicknesses, formation materials, moduli of elasticity, and tensile elongations) may be identical to or different from each other, and may be appropriately selected.

### A-2. Adhesion Layer

As used herein, the term “adhesion layer” refers to a layer for joining the surfaces of adjacent optical members to each other to integrate the optical members with a practically sufficient adhesive strength in a practically sufficient adhesion time. A material for forming the adhesion layer is, for example, a pressure-sensitive adhesive, an adhesive, or an anchor coat agent. The adhesion layer may have such a multilayer structure that an anchor coat layer is formed on the surface of an adherend and an adhesive layer is formed on the anchor coat layer.

The value of the ratio of the thickness of the adhesion layer to the sum of the thickness of the first resin layer and the thickness of the second resin layer is preferably 0.03 or more. When the value falls within such range, the bending property becomes more excellent, and extremely excellent peelability can be achieved. Meanwhile, the value of the ratio of the thickness of the adhesion layer to the sum of the thicknesses of the respective resin layers is preferably 0.40 or less, more preferably 0.35 or less, still more preferably 0.30 or less. When the value falls within such range, warping of a polarizing plate can be extremely satisfactorily suppressed.

The thickness of the adhesion layer is preferably smaller than the thickness of each of the resin layers. The thickness of the adhesion layer is preferably smaller than the thickness of each of the resin layers by a difference of 2 μm or more, more preferably 5 μm or more. When the difference is excessively small, a suppressive effect on warping of a polarizing plate may be insufficient depending on the thicknesses of the resin layers. The thickness of the adhesion layer is typically from 2 μm to 30 μm, preferably from 2 μm to 25 μm, more preferably from 5 μm to 20 μm. When the thickness is excessively large, a problem (such as adhesion deficiency) may occur in the formation of the adhesion layer.

The formation of the adhesion layer can reduce the modulus of elasticity of the protective film to be obtained. The adhesion layer has a storage modulus of elasticity at 23° C. of preferably 8.0×10⁴ or more and less than 1.0×10⁷ Pa. It should be noted that the storage modulus of elasticity of the adhesion layer is measured using a dynamic viscoelastometer under the condition of a frequency of 1 Hz.

The adhesion layer is typically formed of a pressure-sensitive adhesive. A (meth)acrylic pressure-sensitive adhesive is preferably used as the pressure-sensitive adhesive. The (meth)acrylic pressure-sensitive adhesive preferably contains a (meth)acrylic polymer and an isocyanate-based compound.

The (meth)acrylic polymer refers to a polymer or copolymer synthesized from an acrylate-based monomer and/or a methacrylate-based monomer (herein refer red to as “(meth) acrylate”). When the (meth)acrylic polymer is a copolymer, the state of the arrangement of its molecules is not particularly limited, and may be a random copolymer, a block copolymer, or a graft copolymer, A preferred state of molecular arrangement is a random copolymer.

The (meth)acrylic polymer is obtained by, for example, homopolymerizing or copolymerizing an alkyl (meth)acrylate. The alkyl group of the alkyl (meth)acrylate may be linear, branched, or cyclic. The alkyl group of the alkyl (meth)acrylate has preferably about 1 to 18, more preferably 1 to 10 carbon atoms.

Specific examples of the alkyl (meth)acrylate include methyl (meth)acrylate, ethyl (meth)acrylate, propyl (meth)acrylate, n-butyl (meth)acrylate, iso-butyl (meth)acrylate, t-butyl (meth)acrylate, n-pentyl (meth)acrylate, iso-pentyl (meth)acrylate, n-hexyl (meth)acrylate, iso-hexyl (meth)acrylate, n-heptyl (meth)acrylate, iso-heptyl (meth)acrylate, 2-ethylhexyl (meth)acrylate, n-octyl (meth)acrylate, iso-octyl (meth)acrylate, n-nonyl (meth)acrylate, iso-nonyl (meth)acrylate, lauryl (meth)acrylate, stearyl (meth)acrylate, and cyclohexyl (meth)acrylate. Those (meth)acrylates may be used alone or in combination.

The (meth)acrylic polymer is preferably a copolymer of the alkyl (meth)acrylate and a hydroxy group-containing (meth)acrylate. In this case, the alkyl group of the alkyl (meth)acrylate has preferably 1 to 8, more preferably 2 to 8, still more preferably 2 to 6, particularly preferably 4 to 6 carbon atoms. The alkyl group of the alkyl (meth)acrylate maybe linear or branched.

Specific examples of the hydroxy group-containing (meth)acrylate include 2-hydroxyethyl (meth)acrylate, 3-hydroxypropyl (meth)acrylate, 2-hydroxypropyl (meth)acrylate, 4-hydroxybutyl (meth)acrylate, 3-hydroxybutyl (meth)acrylate, 2-hydroxybutyl (meth)acrylate, 5-hydroxypentyl (meth)acrylate, 3-hydroxy-3-methylbutyl (meth)acrylate, 6-hydroxyhexyl (meth)acrylate, 7-hydroxyheptyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methylacrylate. Those (meth)acrylates may be used alone or in combination.

The hydroxyalkyl group of the hydroxy group-containing (meth)acrylate preferably has a smaller number of carbon atoms than that of the alkyl group of the alkyl (meth)acrylate. The hydroxyalkyl group of the hydroxy group-containing (meth)acrylate has preferably 1 to 8, more preferably 2 to 4, still more preferably 2 carbon atoms. By adjusting the numbers of carbon atoms of the alkyl groups as just described, reactivity with the isocyanate-based compound to be described later can be improved, and a pressure-sensitive adhesive having an additionally excellent pressure-sensitive adhesive characteristic can be obtained.

The amount of the hydroxy group-containing (meth)acrylate to be copolymerized is preferably from 0.05 mol % to 0.25 mol %, more preferably from 0.10 mol % to 0.22 mol %, still more preferably from 0.14 mol % to 0.20 mol %.

The (meth)acrylic polymer may be obtained by copolymerizing any other component in addition to the alkyl (meth)acrylate and the hydroxy group-containing (meth)acrylate. The other component is not particularly limited, and it is preferred to use, for example, (meth)acrylic acid, benzyl (meth)acrylate, methoxyethyl (meth)acrylate, ethoxymethyl (meth)acrylate, phenoxyethyl (meth)acrylate, (meth)acrylamide, vinyl acetate, or (meth)acrylonitrile. The amount of the other component to be copolymerized is preferably 100 parts by weight, or less, more preferably 50 parts by weight or less with respect to 100 parts by weight of the alkyl (meth)acrylate.

The (meth)acrylic polymer has a weight-average molecular weight (Mw) of preferably 1,000,000 or more, more preferably from 1,200,000 to 3,000,000, particularly preferably from 1,200,000 to 2,500,000 as a value measured by a gel permeation chromatography (GPC) method using tetrahydrofuran as a solvent.

Examples of the isocyanate-based compound include: isocyanate monomers such as 2,4-(or 2,6-)tolylene diisocyanate, xylylene diisocyanate, 1,3-bis (isocyanatomethyl)-cyclohexane, hexamethylene diisocyanate, norbornene diisocyanate, chlorophenylene diisocyanate, tetramethylene diisocyanate, isophorone diisocyanate, diphenylmethane diisocyanate, trimethylolpropanexylene diisocyanate, and hydrogenated diphenylmethane diisocyanate; adduct-based isocyanate compounds obtained by subjecting any one of the isocyanate monomers to addition with a polyhydric alcohol such as trimethylolpropane; an isocyanurate compound; a biuret-type compound; and a urethane prepolymer-type isocyanate subjected to an addition reaction with, for example, any appropriate polyether polyol, polyester polyol, acrylic polyol, polybutadiene polyol, or polyisoprene polyol. Those compounds may be used alone or in combination.

A commercially available product may be used as it is as the isocyanate-based compound. Examples of the commercially available isocyanate-based compound include: TAKENATE series manufactured by Mitsui Takeda Chemicals, Inc. (e.g., trade names “D-110N, 500, 600, and 700”); and CORONATE series manufactured by Nippon Polyurethane Industry Co., Ltd. (e.g., trade names “L, MR, EH, and HL”).

The content of the isocyanate-based compound is preferably from 0.10 part by weight to 1.5 parts by weight, more preferably from 0.3 part by weight to 1.0 part by weight, particularly preferably from 0.4 part by weight to 0.8 part by weight with respect to 100 parts by weight of the (meth)acrylic polymer. With such content, satisfactory adhesiveness can be obtained even under a harsh (high-temperature and high-humidity) environment.

The (meth)acrylic pressure-sensitive adhesive preferably further contains a silane coupling agent. As the silane coupling agent, for example, a silane coupling agent having any appropriate functional group may be selected. Examples of the functional group include a vinyl group, an epoxy group, a methacryloxy group, an amino group, a mercapto group, an acryloxy group, an acetoacetyl group, an isocyanate group, a styryl group, and a polysulfide group. Specific examples of the silane coupling agent include vinyltrimethoxysilane, γ-glycidoxypropyltrimethoxysilane, γ-glycidoxypropyltriethoxysilane, p-styryltrimethoxysilane, γ-methacryloxypropyltrimethoxysilane, γ-acryloxypropyltrimethoxysilane, N-β(aminoethyl)-γ-aminopropyltrimethoxysilane, γ-aminopropylmethoxysilane, γ-mercaptopropylmethyldimethoxysilane, bis(triethoxysilylpropyl) tetrasulfide, and γ-isocyanatopropyltrimethoxysilane. Of those, a silane coupling agent having an epoxy group is preferred, and γ-glycidoxypropyltrimethoxysilane is more preferred.

A commercially available product may be used as it is as the silane coupling agent. Examples of the commercially available product include: KA series (e.g., trade name “KA-1003”), KBM series (e.g., trade names “KBM-303, KBM-403, and KBM-503”), and KBE series (e.g., trade names “KBE-402, KBE-502, and KBE-903”) manufactured by Shin-Etsu Silicones; and SH series (e.g., trade names “SH6020, SH6040, and SH6062”) and SZ series (e.g., trade names “SZ6030, SZ6032, and SZ6300”) manufactured by Toray Industries, Inc.

The content of the silane coupling agent is preferably from 0.001 part by weight to 2.0 parts by weight, more preferably from 0.005 part by weight to 2.0 parts by weight, still more preferably from 0.01 part by weight to 1.0 part by weight, particularly preferably from 0.02 part by weight to 0.5 part by weight with respect to 100 parts by weight of the (meth)acrylate-based polymer. With such, content, the occurrence of detachment or air bubbles can be suppressed even under a harsh (high-temperature and high-humidity) environment.

### A-3. Lamination Method

Any appropriate method may be adopted as a method of laminating the first resin layer and the second resin layer. In a preferred embodiment, there is adopted a method involving forming the adhesion layer on one of the resin layers, and laminating the other resin layer on the adhesion layer. Any appropriate method may be adopted as a method of forming the adhesion layer. Specifically, for example, the adhesion layer is formed by applying the (meth)acrylic pressure-sensitive adhesive onto the resin layer, followed by heating. When applied, the (meth)acrylic pressure-sensitive adhesive preferably has its polymer concentration appropriately adjusted with a solvent (such as ethyl acetate or toluene). A heating temperature is preferably from 20° C. to 200° C., more preferably from 50° C. to 170° C.

### A-4. Others

The pressure-sensitive adhesive layer is formed of any appropriate pressure-sensitive adhesive. A (meth)acrylic pressure-sensitive adhesive is typically used as the pressure-sensitive adhesive. The thickness of the pressure-sensitive adhesive layer is preferably from 15 μm to 25 μm. A resin film (such as a polyester-based resin film) having formed thereon a peelability-imparting layer is typically used as the separator.

### A-5. Attaching Method

The protective film of the present invention is preferably attached onto the convex surface of a polarizing plate on which warping has occurred. It should be noted that when, for example, a protective layer is arranged only on one side of a polarizer, warping that is convex to the protective layer side tends to occur. The protective film is preferably attached onto the polarizing plate while a tension is applied to the protective film. This is because such operation can generate a residual shrinkage stress in the protective film. The tension is preferably applied in a direction corresponding to the absorption axis direction of the polarizer of the polarizing plate after the attachment. The tension may be appropriately set depending on the construction of the protective film (including its thickness, formation material, modulus of elasticity, and tensile elongation).

### B. Polarizing Plate Provided With Protective Film

FIG. 2 is a schematic sectional view of a polarizing plate provided with a protective film according to a preferred embodiment of the present invention. A polarizing plate provided with a protective film 100 includes a polarizing plate 30 and the protective film 10 attached onto the surface of the polarizing plate 30 by means of the pressure-sensitive adhesive layer 20. The polarizing plate 30 includes a polarizer 31, a protective layer 32 and optical member 33 arranged on one side of the polarizer 31, and an optical member 34 and separator 35 arranged on the other side of the polarizer 31. The protective film 10 is attached onto the polarizer 31 on the side on which the protective layer 32 is arranged. The separator 35 is detached before use (for example, bonding of the polarizing plate provided, with a protective film onto a liquid crystal cell). It should be noted that any appropriate pressure-sensitive adhesive or adhesive is used for the lamination of the constituent layers of the polarizing plate.

In the polarizing plate provided with a protective film of the present invention, warping is satisfactorily suppressed even when the construction of the polarizing plate changes. Specifically, for example, when the separator is detached from the polarizing plate provided with a protective film, the direction of the warping is reversed in some cases (particularly in the case where the protective film has been attached with the application of a tension). However, the use of the protective film of the present invention can satisfactorily suppress such warping as well. One possible factor therefor is the fact that the protective film of the present invention has a higher second moment of area, a lower modulus of elasticity, and a larger amount of shrinkage upon removal of a tension than those of a resin layer alone.

The polarizing plate includes a polarizer and a protective layer arranged on at least one side of the polarizer. From the viewpoints of reductions in the thickness and weight of the polarizing plate, a construction in which the protective layer is arranged on only one side of the polarizer is preferred. However, with such asymmetric construction with respect to the polarizer, the occurrence of warping may become remarkable.

Examples of the polarizer include: a hydrophilic polymer film, such as a polyvinyl alcohol-based film, a partially formalized polyvinyl alcohol-based film, or an ethylene-vinyl acetate copolymer-based partially saponified film, on which a dichromatic substance such as iodine or a dichromatic dye is adsorbed and oriented; and a polyene-based orientation film such as a dehydration treatment product of polyvinyl alcohol or a dehydrochlorination treatment product of polyvinyl chloride. Of those, a polarizer that is a polyvinyl alcohol-based film on which a dichromatic substance such as iodine is adsorbed and oriented is particularly preferred because of its high polarized dichromaticity.

The thickness of the polarizer is typically from about 1 μm to 80 μm, preferably from 5 μm to 40 μm.

The protective layer is formed of any appropriate film that may be used as the protective layer of the polarizer. As a material for the film as its main component, there is specifically given, for example, a cellulose-based resin such as triacetyl cellulose (TAC), or a transparent resin such as a polyester-based, polyvinyl alcohol-based, polycarbonate-based, polyamide-based, polyimide-based, polyether sulfone-based, polysulfone-based, polystyrene-based, poly norbornene-based, polyolefin-based, (meth)acrylic, or acetate-based resin. In addition, there is also given, for example, a thermosetting resin or UV curable resin such as a (meth)acrylic, urethane-based, (meth)acrylic urethane-based, epoxy-based, or silicone-based resin. In addition, there is also given, for example, a vitreous polymer such as a siloxane-based polymer. In addition, a polymer film described in JP 2001-343529 A (WO 01/37007) may also be used. As a material for the film, there may be used, for example, a resin composition containing: a thermoplastic resin having a substituted or unsubstituted imide group in a side chain; and a thermoplastic resin having a substituted or unsubstituted phenyl group and a nitrite group in a side chain, and an example thereof is a resin composition containing: an alternating copolymer formed of isobatene and N-methylmaleimide; and an acrylonitrile-styrene copolymer. The polymer film may be, for example, an extruded product of the resin composition.

The thickness of the protective layer is preferably from 5 μm to 200 μm, more preferably from 10 μm to 100 μm. It should be noted that the protective layer may function as an optical compensation layer.

Examples of the optical member include an optical compensation layer (retardation layer) and a brightness enhancement film. The separator is as described in the section A-4.

### EXAMPLES

Hereinafter, the present invention is specifically described by way of Examples, but the present invention is not limited by Examples below. It should be noted that measurement methods for various characteristics are as described below.

### 1. Thickness

The measurement was performed with a digital micrometer (manufactured by ANRITSU CORPORATION, product name “KC-351C”).

### 2. Elastic Modulus and Tensile Elongation

The measurement was performed with a tensile tester (manufactured by Shimadzu Corporation, product name: Autograph) in conformity with JIS K 6781.

### Example 1

### Preparation of Pressure-Sensitive Adhesive

A reaction vessel equipped with a condenser tube, a nitrogen inlet tube, a thermometer, and a stirrer was loaded, with 100 parts by weight of butyl acrylate, 5.0 parts by weight of acrylic acid, 0.075 part by weight of 2-hydroxyethyl acrylate, 0.3 part by weight of 2,2′-azobisisobutyronitrile, and ethyl acetate. Under a nitrogen gas stream, the stirred mixture was subjected to a reaction at 60° C. for 6 hours to obtain an acrylic polymer solution having a weight-average molecular weight of 1,630,000. With respect to 100 parts by weight of the polymer solid content of the acrylic polymer solution, 0.6 part by weight of an isocyanate-based polyfunctional compound (manufactured, by Nippon Polyurethane Industry Co., Ltd., trade name: CORONATE L) and 0.08 part by weight of a silane coupling agent (manufactured by Shin-Etsu Chemical Co., Ltd., trade name: KBM403) were added to prepare a pressure-sensitive adhesive.

The pressure-sensitive adhesive was applied onto a polyester-based resin film (manufactured by Mitsubishi Plastics, Inc., trade name: T100F, thickness: 38 μm, modulus of elasticity: 4,090 N/mm², tensile elongation; 59%), followed by heating at 90° C. to form an adhesion layer having a thickness of 12 μm. The obtained adhesion layer had a storage modulus of elasticity at 23° C. of 1.0×10⁵ Pa.

After that, a polyester-based resin film (manufactured by NITTO DENKO CORPORATION, trade name: RP301, thickness: 38 μm, modulus of elasticity: 4,050 N/mm², tensile elongation; 58%) was laminated on the adhesion layer to obtain a protective film having a thickness of 88 μm. The obtained protective film had a modulus of elasticity of 3.6 kN/mm² and a tensile elongation of 91%.

### Example 2

A protective film was produced in the same manner as in Example 1 except that an adhesion layer having a thickness of 9 μm was formed. The obtained protective film had a modulus of elasticity of 3.7 kN/mm² and a tensile elongation of 89%.

### Example 3

A protective film was produced in the same manner as in Example 1 except that an adhesion layer having a thickness of 3 μm was formed. The obtained protective film had a modulus of elasticity of 3.7 kN/mm² and a tensile elongation of 80%.

### Example 4

A protective film was produced in the same manner as in Example 1 except that an adhesion layer having a thickness of 20 μm was formed. The obtained protective film had a modulus of elasticity of 3.6 kN/mm² and a tensile elongation of 98%.

### Example 5

A protective film was produced in the same manner as in Example 1 except that an adhesion layer having a thickness of 25 μm was formed. The obtained protective film had a modulus of elasticity of 3.5 kN/mm² and a tensile elongation of 105%.

### Example 6

A protective film was produced in the same manner as in Example 1 except that an adhesion layer having a thickness of 30 μm was formed. The obtained protective film had a modulus of elasticity of 3.5 kN/mm² and a tensile elongation of 109%.

### Example 7

A protective trim was produced in the same manner as in Example 1 except that a polyester-based resin film having a thickness of 25 μm (manufactured by Mitsubishi Plastics, Inc., trade name: T100-25B, modulus of elasticity: 3.510 N/mm², tensile elongation: 101%) was used in place of the polyester-based resin film having a thickness of 38 μm (trade name: T100F). The obtained protective film had a modulus of elasticity of 3.5 kN/mm² and a tensile elongation of 92%.

### Example 8

A protective film was produced in the same manner as in Example 7 except that an adhesion layer having a thickness of 9 μm was formed. The obtained protective film had a modulus of elasticity of 3.6 kN/mm² and a tensile elongation of 91%.

### Example 9

A protective film was produced in the same manner as in Example 7 except that an adhesion layer having a thickness of 3 μm was formed. The obtained protective film had a modulus of elasticity of 3.8 kN/mm² and a tensile elongation of 80%.

### Example 10

A protective film was produced in the same manner as in Example 7 except that an adhesion layer having a thickness of 15 μm was formed. The obtained protective film had a modulus of elasticity of 3.5 kN/mm² and a tensile elongation of 90%.

### Comparative Example 1

A polyester-based resin film (manufactured by NITTO DENKO CORPORATION, trade name: RP207F, thickness: 38 μm, modulus of elasticity; 4.050 N/mm², tensile elongation: 58%) was used as a protective film.

### Comparative Example 2

A polyester-based resin film (manufactured by FUJIMORI KOGYO CO., LTD., trade name: TC-815, thickness: 111 μm, modulus of elasticity: 4.630 N/mm² tensile elongation: 102%) was used as a protective film.

The degree to which warping of a polarizing plate was suppressed by the protective film of each of Examples and Comparative Examples was evaluated. In addition, the peelability of the protective film was evaluated. Details of evaluation methods are as described below.

### Production of Polarizer

A polymer film having a thickness of 60 μm and containing a polyvinyl alcohol-based resin as a main component (manufactured by KURARAY CO., LTD., trade name: VF-PE-A NO. 6000) was immersed in five baths under the following conditions (1) to (5) while a tension was applied in the lengthwise direction or the film, to be stretched so that the final stretching ratio was 6.2 times the original length of the film. The stretched film was dried in an air circulating drying oven at 40° C. for 1 minute to produce a polarizer having a thickness of 22 μm.

### Conditions

(1) Swelling bath: pure water at 30° C.

(2) Dyeing bath: an aqueous solution at 30° C. containing 0.035 part by weight of iodine with respect to 100 parts by weight of water and 0.2 part by weight of potassium iodide with respect to 100 parts by weight of water.

(3) First cross-linking bath: an aqueous solution at 40° C. containing 3 wt % of potassium iodide and 3 wt % of boric acid.

(4) Second cross-linking bath: an aqueous solution at 60° C. containing 5 wt % of potassium, iodide and 4 wt % of boric acid.

(5) Water washing bath: an aqueous solution at 25° C. containing 3 wt % of potassium iodide.

### Production of Protective Layer

Pellets of a mixture of 90 parts by weight of a (meth)acrylic resin having a lactone ring structure represented by the following general formula (1) where R¹ represents a hydrogen atom, and R² and R³ each represent a methyl group (copolymerization monomer weight ratio=methyl methacrylate/methyl 2-(hydroxymethyl)acrylat=8/2, lactone cyclization ratio: about 100%, content of lactone ring structure: 19.4%, weight-average molecular weight: 133,000, melt flow rate: 6.5 g/10 minutes (240° C., 10 kgf), Tg: 131° C.) and 10 parts by weight of an acrylonitrile-styrene (AS) resin (TOYO AS AS20, manufactured by TOYO STYRENE Co., Ltd.), the mixture having a Tg of 127° C., were supplied to a twin-screw extruder and melt-extruded into a sheet shape at about 280° C. to obtain a (meth)acrylic resin sheet having a thickness of 40 μm and having a lactone ring structure. This unstretched sheet was stretched under the temperature condition of 160° C. at a ratio of 2.0 times in its longitudinal direction and at a ratio of 2.4 times in its lateral direction to obtain a protective layer having a thickness of 20 μm.

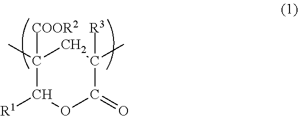

### Production of Polarizing Plate

The protective layer was laminated on one side of the polarizer with a polyvinyl alcohol-based adhesive, a pressure-sensitive adhesive layer having a thickness of 22 μm was formed on the other side, and a separator having a thickness of 38 μm was attached onto the pressure-sensitive adhesive layer surface. Thus, a polarizing plate was produced.

### Production of Polarizing Plate Provided With Protective Film

A pressure-sensitive adhesive layer (thickness: 23 μm) was formed on one side of the protective film of each of Examples and Comparative Examples (second resin layer side in the protective film of each of Examples), and the resultant was attached onto the protective layer side of the obtained polarizing plate to obtain a polarizing plate provided with a protective film. When the attachment was performed, a tension of 190 gf/10 mm was applied to the protective film in a direction corresponding to the absorption axis direction of the polarizer of the polarizing plate after the attachment.

### Measurement of Warping

Warping before the peeling of the separator and that after the peeling were measured. A method of measuring the warping is as described below, A test piece measuring 10 cm long by 6 cm wide was cut out of the polarizing plate so that the absorption axis direction of the polarizer became one side. The obtained test piece was placed on a glass plate so that its convex surface was on the lower side, and the height of each of the four corners of the test piece from the glass plate was measured. The largest of the values at the four corners was used to make an evaluation. The measurement results are shown together in Table 1. It should be noted that warping that is convex to the protective layer side with respect to the polarizer is represented by Symbol “+”, and warping that is convex to the side on which the protective layer is not arranged, with respect to the polarizer is represented by Symbol “−”.

### Peelability

A cellophane tape was attached onto the protective film of the obtained polarizing plate provided with a protective film, and the protective film was peeled off by holding an end portion of the cellophane tape to evaluate the peelability of the protective film. Evaluation criteria are as described below, and the evaluation results are shown together in Table 1.

### Evaluation Criteria

⊚: Extremely satisfactory (easily peelable)

o: Satisfactory

x: Peeling failure occurs (only the cellophane tape is peeled off and the protective film is left).

TABLE 1

| | Thickness of resin | | | Adhesion layer | | Modulus of | Warping amount (mm) | | |
|---|---|---|---|---|---|---|---|---|---|
| | layer (μm) | | | Thickness | | elasticity | Before | After | |
| | First | Second | Sum | (μm) | Ratio | kN/mm² | peeling | peeling | Peelability |
| Example 1 | 38 | 38 | 76 | 12 | 0.16 | 3.6 | +2.0 | −3.0 | ⊚ |
| Example 2 | 38 | 38 | 76 | 9 | 0.12 | 3.7 | +2.0 | −3.0 | ⊚ |
| Example 3 | 38 | 38 | 76 | 3 | 0.04 | 3.7 | +1.8 | −2.9 | ◯ |
| Example 4 | 38 | 38 | 76 | 20 | 0.26 | 3.6 | +2.2 | −3.5 | ⊚ |
| Example 5 | 38 | 38 | 76 | 25 | 0.33 | 3.5 | +2.5 | −3.7 | ⊚ |
| Example 6 | 38 | 38 | 76 | 30 | 0.39 | 3.5 | +2.2 | −3.5 | ⊚ |
| Example 7 | 25 | 38 | 63 | 12 | 0.19 | 3.5 | +2.5 | −3.3 | ⊚ |
| Example 8 | 25 | 38 | 63 | 9 | 0.14 | 3.6 | +2.6 | −4.0 | ⊚ |
| Example 9 | 25 | 38 | 63 | 3 | 0.05 | 3.8 | +2.1 | −3.1 | ◯ |
| Example 10 | 25 | 38 | 63 | 15 | 0.24 | 3.5 | +2.7 | −4.1 | ⊚ |
| Comparative | — | 38 | — | — | — | 4.1 | +4.0 | −6.0 | ⊚ |
| Example 1 | | | | | | | | | |
| Comparative | — | 111 | — | — | — | 4.6 | +2.0 | −3.0 | X |
| Example 2 | | | | | | | | | |

The protective film of each of Examples having a laminated structure satisfactorily suppressed warping and was excellent in peelability. The protective film of Comparative Example 2 having a large thickness was able to satisfactorily suppress warping but was poor in peelability. One possible cause for this is a reduction in bending property due to, for example, the influence of a high second moment of area or a high modulus of elasticity. It should be noted that in Example 4, adhesive deficiency occurred in the adhesion layer.

### INDUSTRIAL APPLICABILITY

The protective film, of the present invention is suitably used as a protective film for a polarizing plate.

### REFERENCE SIGNS LIST

10 protective film

11 first resin layer

12 second resin layer

13 adhesion layer

20 pressure-sensitive adhesive layer

30 polarizing plate

31 polarizer

32 protective layer

100 polarizing plate provided with protective film

1.-8. (canceled)

9. A protective film for a polarizing plate, comprising a first resin layer, an adhesion layer, a second resin layer, and a pressure-sensitive adhesive layer in the stated order,
wherein:
a value of a ratio of a thickness of the adhesion layer to a sum of a thickness of the first resin layer and a thickness of the second resin layer is 0.40 or less;
the adhesion layer has a storage modulus of elasticity at 23° C. of 8.0×10⁴ Pa or more and less than 1.0×10⁷ Pa; and
the protective film is integrally attachable onto a surface of a polarizing plate, and is integrally peelable from the surface of the polarizing plate.

10. A protective film according to claim 1, wherein the adhesion layer has a thickness of from 2 μm to 25 μm.

11. A protective film according to claim 1, wherein at least one of the first resin layer and the second resin layer comprises a polyester-based resin film.

12. A protective film according to claim 1, wherein at least one of the first resin layer and the second resin layer has a modulus of elasticity measured in conformity with JIS K 6781 of from 4.0 kN/mm² to 4.7 kN/mm².

13. A protective film according to claim 1, wherein the protective film has a modulus of elasticity measured in conformity with JIS K 6781 of from 3.5 kN/mm² to 3.8 kN/mm².

14. A polarizing plate provided with a protective film, comprising:
a polarizing plate; and
the protective film according to claim 1 peelably attached onto a surface of the polarizing plate.
